(19) United States
(12) Patent Application Publication
(10) Pub. No.: US 2003/0177644 A1
(43) Pub. Date: Sep. 25, 2003

(54) Tree pruner

(76) Inventor: Kun-chia Cheng, Changhwa City (TW)

Correspondence Address: Jackson Walker L.L.P., Suite 2100, 112 E. Pecan Street, San Antonio, TX, 78205, US

(21) Appl. No.: 10/105,457

(22) Filed: Mar. 25, 2002

(51) Int. Cl. B26B 13/26

(52) U.S. Cl. 30/249; 30/245; 30/272.1

(57) ABSTRACT

A tree pruner has a support rod, a cutting set and pull cord. The cutting set is mounted on the top end of the support rod and has a fixed blade, a moving blade and a driving lever. The fixed blade is securely connected to the top end of the support rod and has multiple fixed teeth formed on an edge of the fixed blade. The cutting blade is pivotally attached to the fixed blade. The driving lever is pivotally attached to one end of the cutting blade and has multiple moving teeth formed on the driving lever to engage with the fixed teeth on the fixed blade. With such a cutting set, the travel of pulling the pull cord can be increased, such that the cutting set can cut off with ease a tree part with a large diameter.

### BACKGROUND OF THE INVENTION

1. Field of the Invention

The present invention relates to a tree pruner, and more particularly to a tree pruner that can prune a tree with ease.

2. Description of Related Art

To cut off a dead or a living part of a tree, a tree pruner with a rod is used so that it is not necessary to climb the tree and the user can easily trim the tree at a low location. With reference to FIG. 10, a conventional tree pruner in accordance with the prior art comprises a support rod (60), a cutting set (62) and a pull cord (64). The cutting set (62) is arranged on a top end of the support rod (60) and comprises a fixed blade (622), a cutting blade (624) and an actuating link device (626). The fixed blade (622) is secured to the top end of the support rod (60), and the cutting blade (624) is pivotally attached to the fixed blade (622). Both the fixed blade (622) and the cutting blade (624) have a blade portion corresponding to each other. The actuating link device (626) is pivotally connected with the blades (622,624) to actuate the cutting blade (624) to pivotally rotate relative to the fixed blade (622). The pull cord (64) is wound around pulleys on the actuating link device (626) and the support rod (60). Accordingly, the cutting blade (624) can pivotally rotate relative to the fixed blade (622) to cut off an object by means of the transmission of the actuating link device (626) when the user pulls the pull cord (64). In addition, a tension spring (not numbered) is mounted between the fixed blade (622) and the actuating link device (626) to return the cutting blade (624) to the original position when the user releases the pull cord (64).

However, the cutting set (62) of the conventional tree pruner is not able to cut off a tree part with a large diameter due to the limited travel of the actuating link device (626). In addition, because there is no structure on the conventional tree pruner to hold the pull cord (64), the pull cord (64) is always wound around the support rod (60) when the tree pruner is not in use. It is very troublesome to stow the pull cord (64) of the conventional tree pruner.

To overcome the shortcomings, the present invention tends to provide a tree pruner to mitigate or obviate the aforementioned problems.

### SUMMARY OF THE INVENTION

The main objective of the invention is to provide a tree pruner that can easily cut off a tree part. The tree pruner has a support rod, a cutting set and pull cord. The cutting set is mounted on the top end of the support rod and has a fixed blade, a moving blade and a driving lever. The fixed blade is securely connected to the top end of the support rod and has multiple fixed teeth formed on an edge of the fixed blade. The cutting blade is pivotally attached to the fixed blade. The driving lever is pivotally attached to one end of the cutting blade and has multiple moving teeth formed on the driving lever to engage with the fixed teeth on the fixed blade. Wherein, the distance between adjacent both fixed and moving teeth is larger than the maximum width of each tooth to keep one side of each engaging tooth from touching the other. At least one upper pulley and at least one lower pulley are respectively rotatably mounted on driving lever and the support rod for the pull cord wound around the pulleys. In such an arrangement of the cutting set, the travel of the pull cord can be increased, such that the cutting set can easily cut off a tree part with a large diameter.

Other objects, advantages and novel features of the invention will become more apparent from the following detailed description when taken in conjunction with the accompanying drawings.

### BRIEF DESCRIPTION OF THE DRAWINGS

FIG. 1 is a side plan view of a tree pruner in accordance with the present invention;

FIG. 2 is an enlarged side plan view of the cutting set of the tree pruner in FIG. 1;

FIG. 3 is an operational side plan view of the cutting set in FIG. 2;

FIG. 4 is an enlarged side plan view of the teeth on the fixed blade and the driving lever of the cutting set in FIG. 3;

FIG. 5 is an operational side plan view of the tree pruner in FIG. 1 showing that the saw is expanded to an operational position;

FIG. 6 is a top plan view in partial cross section of the upper holder with the saw in FIG. 5 showing that the saw is positioned by an engaging bolt;

FIG. 7 is an operational top plan view in partial cross section of the upper holder with the saw in FIG. 6 showing that the saw is disengaged from the engaging bolt;

FIG. 8 is an enlarged operational side plan view of the saw in FIG. 5 showing that the position of the saw is adjusted;

FIG. 9 is a cross sectional top plan view of the cord holder on the support rod of the tree pruner in FIG. 1; and

FIG. 10 is a perspective view of a conventional tree pruner in accordance with the prior art.

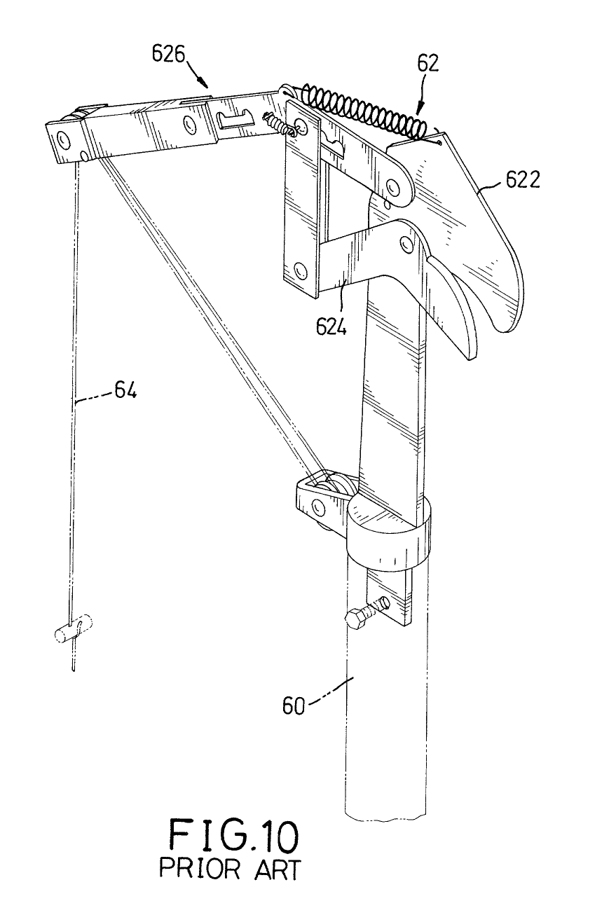

### DETAILED DESCRIPTION OF PREFERRED EMBODIMENT

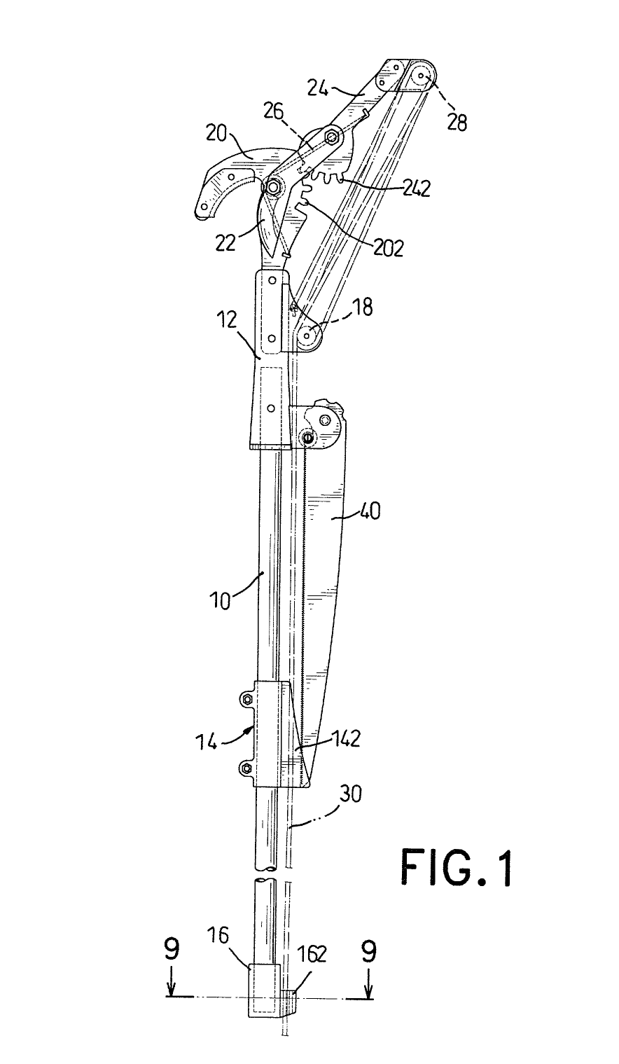

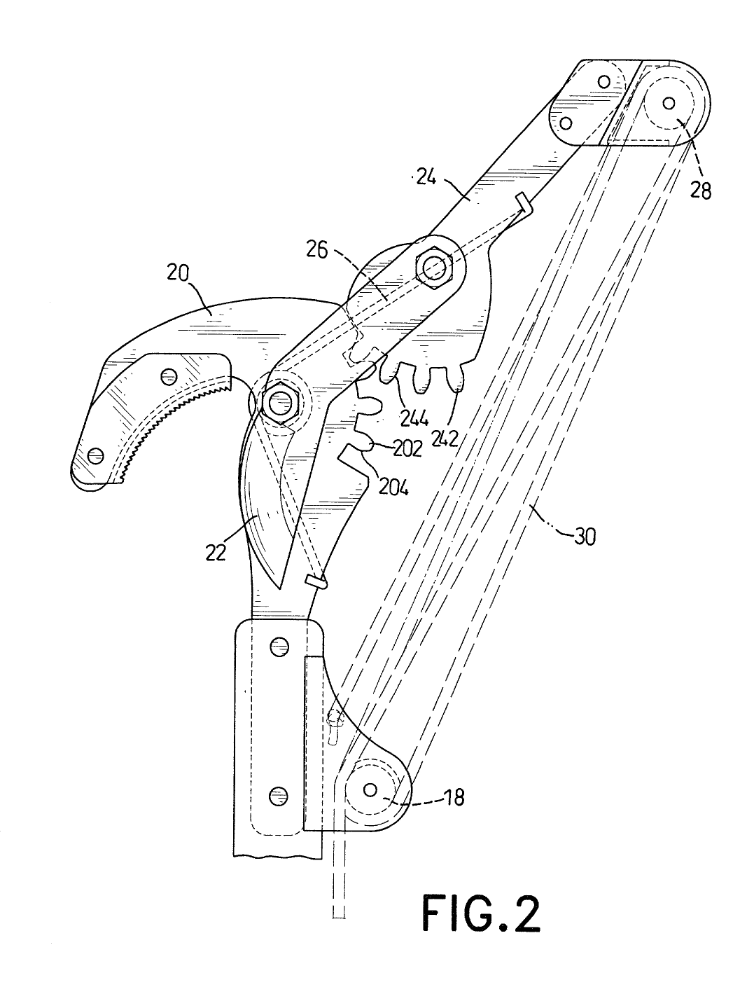

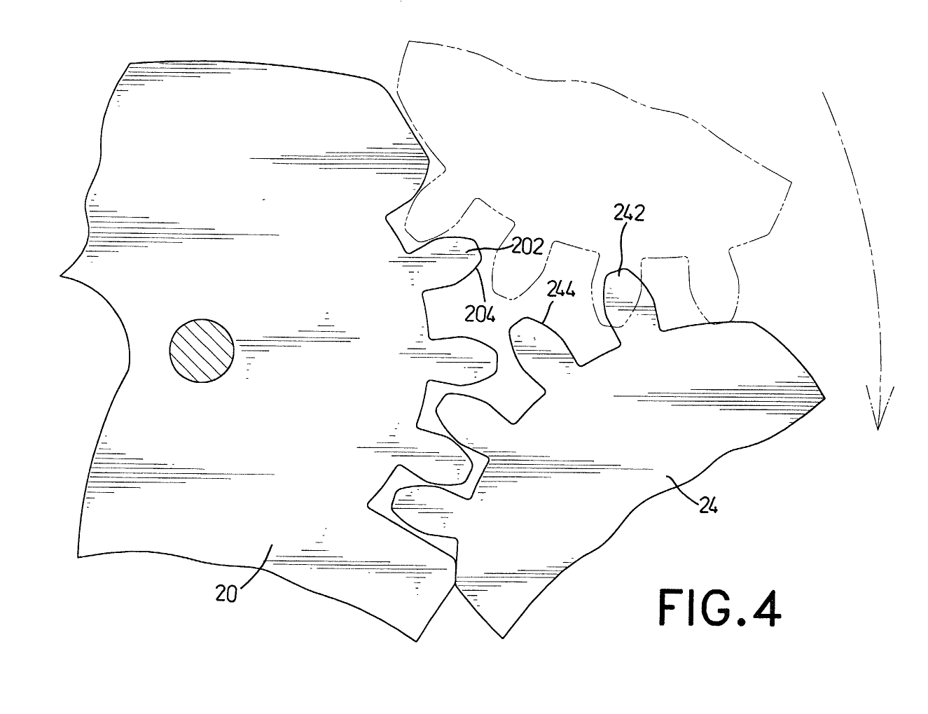

With reference to FIGS. 1 and 2, a tree pruner in accordance with the present invention comprises a support rod (10), a cutting set and a pull cord (30). The cutting set is mounted on the top end of the support rod (10) through an upper holder (12), wherein the upper holder (12) is secured on the top end of the support rod (10). Two lower pulleys (18) are rotatably mounted on the upper holder (12). The cutting set comprises a fixed blade (20), a cutting blade (22) and a driving lever (24). The fixed blade (20) is secured to the upper holder (12), and the cutting blade (22) is pivotally attached to the fixed blade (20). Both the fixed blade (20) and the cutting blade (22) have a blade portion corresponding to each other. Multiple fixed teeth (202) are formed on one edge of the fixed blade (20) far from the blade portion of the fixed blade (20). The driving lever (24) is pivotally attached to the cutting blade (22) at the end far from the blade portion of the cutting blade (22). Multiple moving teeth (242) are formed on one end of the driving lever (24), and at least one of the moving teeth (242) engages with the fixed teeth (202) on the fixed blade (20). With reference to FIGS. 2 and 4, the distance between adjacent both fixed and moving teeth (202,242) is larger than the maximum width of each tooth (202,242) to keep one side of each engaging tooth (202,242) from touching the other. An oblique face (204,244) is formed on each respective side of a free end of each respective tooth (202,,242). In addition, two upper pulleys (28) are rotatably mounted on the other end of the driving lever (24) opposed to the moving teeth (242). A torsion spring (26) is attached to the fixed blade (20) and has two ends respectively connected to the fixed blade (20) and the driving lever (24) to provide a recoil force to the driving lever (24).

The pull cord (30) is mounted around the lower pulleys (18) on the upper holder (12) and the upper pulleys (28) on the driving lever (24). The pull cord (30) has a first end secured to the upper holder (12) and a second extending to the bottom end of the support rod (10). In another practice embodiment, one lower pulley (18) and one upper pulley (20) are respectively mounted on the upper holder (12) and the driving lever (24) for the pull cord (30) wound around the pulleys (18,28).

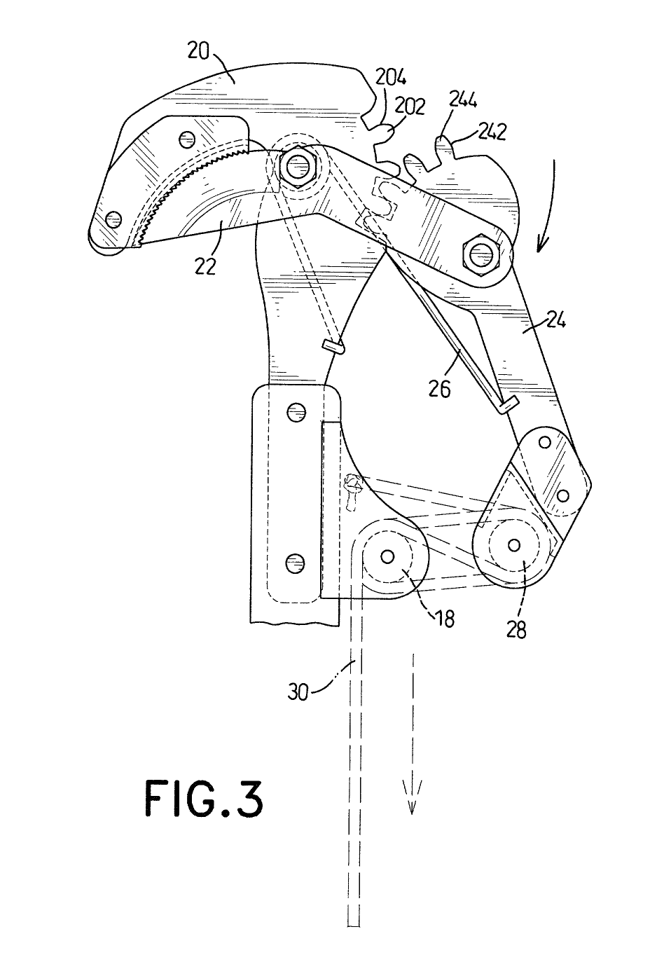

With reference to FIGS. 1 to 4, when the user pulls the pull cord (30) downward, the driving lever (24) will be forced to move downward with the transmission of the pulleys (18,28). The moving teeth (242) on the driving lever (24) will move relative to the fixed teeth (202) on the fixed blade (20), and the cutting blade (22) will pivotally rotate relative to the fixed blade (20) so as to cut off an object between the blades (20,22). During the rotation of the driving lever (24), the rotating centers of the driving lever (24) relative to the fixed blade (20) are variable along the fixed teeth (202), such that the travel of the pull cord (30) for moving the driving lever (24) downward is increased. Consequently, the force applied to the pruned object is increased, such that the user can easily prune an object with a large diameter.

In addition, due to the large distance between adjacent teeth (202,242), one side of each moving tooth (242) will not contact with the corresponding one of the fixed tooth (202) when the moving tooth (242) disengages from the corresponding fixed tooth (202). With the arrangement of the oblique faces (204,244) on the teeth (202,242), the interruption between the teeth (202,242) will be prevented. Accordingly, the movement of the moving teeth (242) relative to the fixed teeth (202) is particularly smooth.

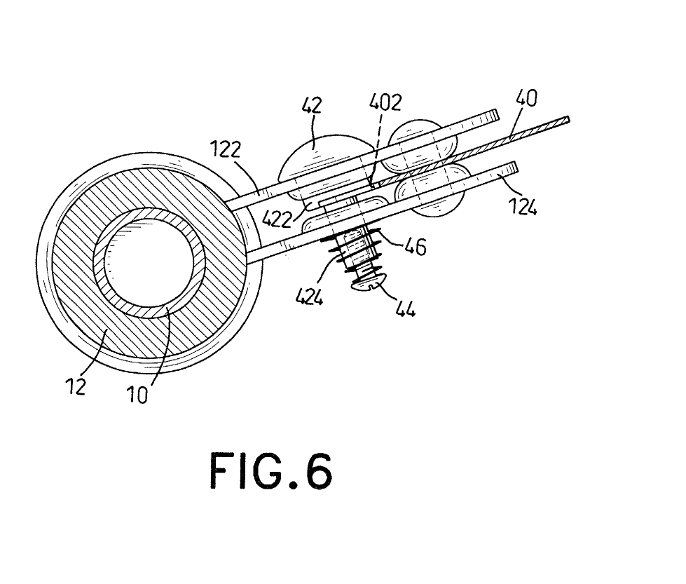

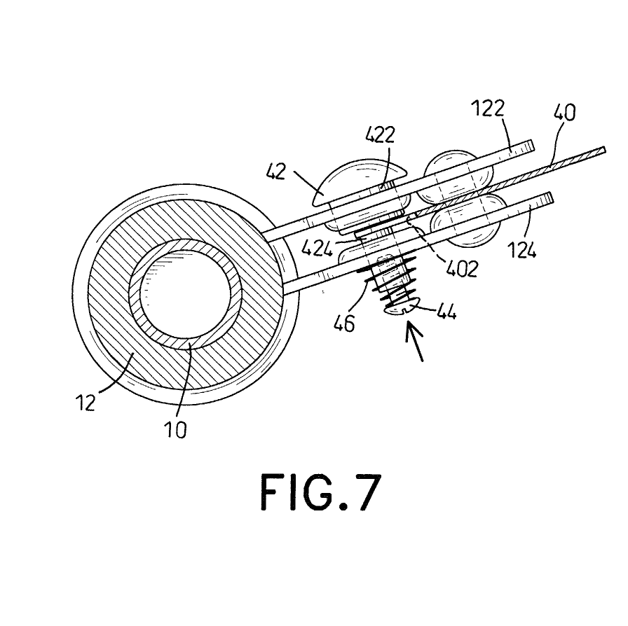

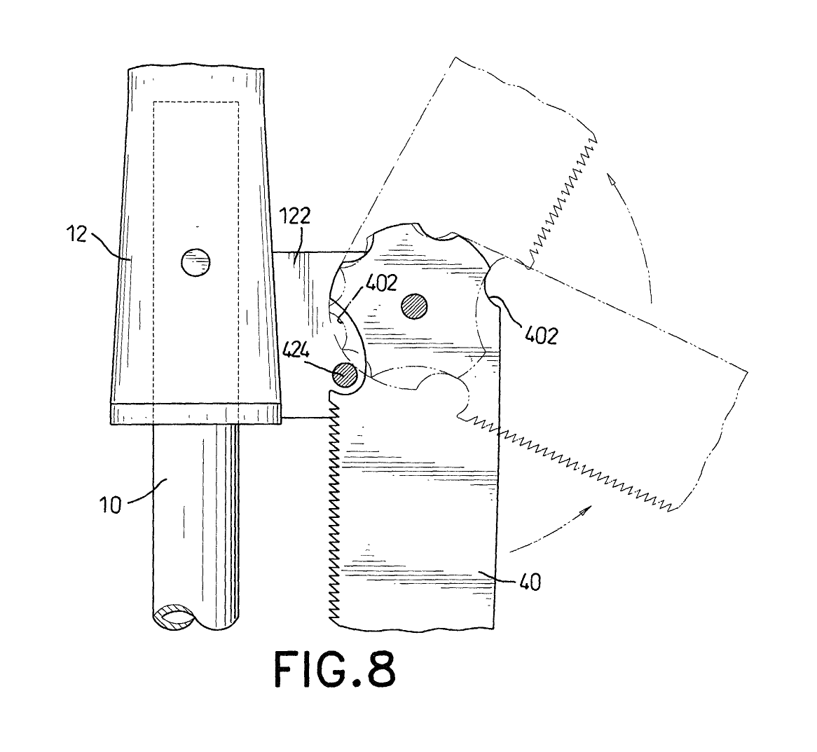

With reference to FIGS. 1 and 5 to 8, a saw (40) is adjustably mounted attached to the upper holder (12) at an angle. In practice, two flanges (122,124) extend from the upper holder (12) and are parallel to each other. The saw (40) is pivotally attached between the flanges (122,124) with a pivot (not numbered). Multiple notches (402) are defined in one end of the saw (40) at a center of the pivot. An engaging bolt (42) is operationally attached between the flanges (122,124) to position the saw (40) at desired angles. The engaging bolt (42) has an engaging portion (422) extending through one of the flange (122) and into a space defined between the two flanges (122,124). The engaging portion (422) corresponds to the notches (402) on the saw (40) and engages with one of the notches (402) so as to position the saw (40) relative to the upper holder (12) at a desired angle. A releasing portion (424) co-axially extends from the engaging portion (422) and extends through another flange (124). The releasing portion (424) has a diameter smaller than that of the engaging portion (422). A biasing member (46) is mounted around the releasing portion (424) at the end extending through the flange (124). One end of the biasing member (46) abuts the flange (46) through which the releasing portion (424) extends, the other end of the biasing member (46) abuts a pressing bolt (44) which is screwed to the releasing portion (424).

With the saw (40), the user can saw a tree part having a diameter so large that the cutting set cannot prune, such that to trim a tree part with a large diameter is convenient.

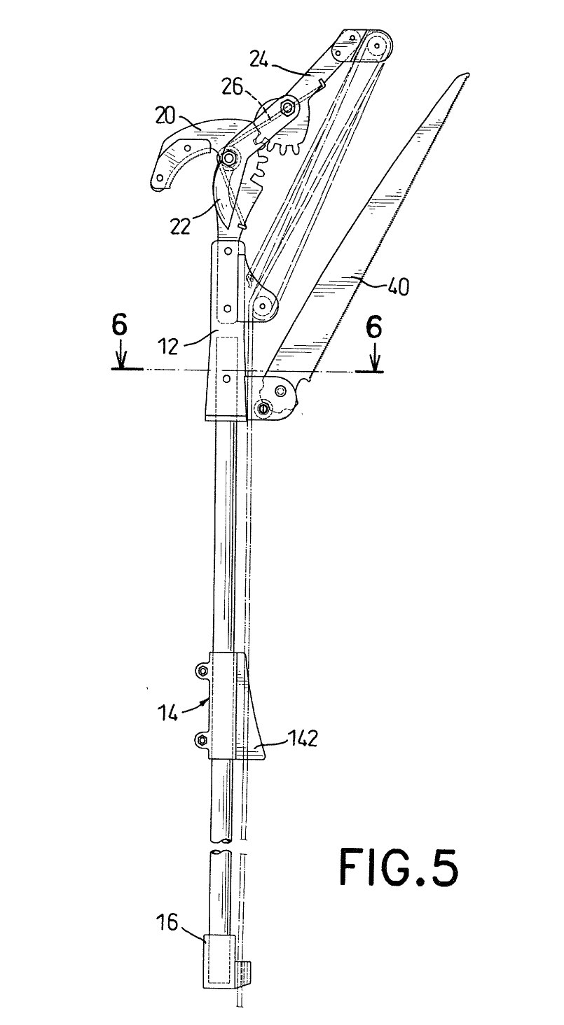

To adjust the angle of the saw (40), with reference to FIGS. 5, 7 and 8, the pressing bolt (44) is pressed to push the engaging bolt (42) to move relative to the flanges (122,124). The engaging portion (422) will disengage from the corresponding notch (402), and the releasing portion (424) will face the notch (402). Consequently, the saw (40) will be released from the engaging bolt (42), and the saw (40) can rotate relative to the upper holder (12). When the saw (40) is rotated to a desired position, the pressing bolt (44) is released so that the engaging bolt (42) will move backward due to the recoil force provided by the biasing member (46). The engaging portion (424) of the engaging bolt (42) will engage with the corresponding notch (402) to position the saw (40). This can adjust the angle of the saw (40) relative to the support rod (10) and even to fold the saw (40) to a closed condition as shown in FIG. 1. In addition, a saw cover (14) is mounted on the support rod (10) and has two parallel flanges (142) extending from the saw cover (14). The free end of the saw (40) is received in a space defined between the flanges (142) on the saw cover (14) when the saw (40) is folded in a closed condition. This can keep the notched edge of the saw (40) from contacting and harming any person or other object.

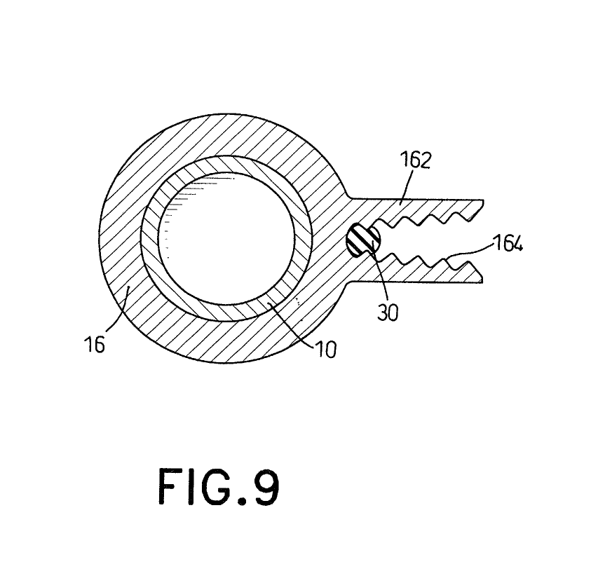

With reference to FIGS. 1 and 9, a cord holder (16) is secured on the bottom of the support rod (10) and has two parallel ears (162) extending from the cord holder (16). A toothed face (164) is formed on each respective ear (162) at a side facing the other ear (162). With the cord holder (16), the bottom portion of the pull cord (30) can be pulled into the space defined between the ears (162) on the cord holder (16) and be securely engaged by the toothed faces (164) on the ears (162). This can easily retain the pull cord (30) when the tree pruner is not in use.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A tree pruner comprising:
a support rod;
a fixed blade securely connected to a top end of the support rod and having a blade portion formed on one end of the fixed blade far from the support rod and multiple fixed teeth formed on an edge of the fixed blade far from the blade portion;
a cutting blade pivotally attached to the fixed blade and having a blade portion corresponding to the blade portion of the fixed blade;
a driving lever pivotally attached to one end of the cutting blade far from the blade portion of the cutting blade and having moving multiple teeth formed on a first end of the driving lever to engage with the fixed teeth on the fixed blade;
a torsion spring attached to the fixed blade and having two ends respectively connected to the fixed blade and the driving lever;
at least one upper pulley rotatably mounted on a second end of the driving lever;
at least one lower pulley rotatably mounted on the support rod; and
a pull cord wound around the at least one upper pulley and the at least one lower pulley and having a first end securely connected to the support rod and a second end extending to a bottom end of the support rod, wherein
a distance between adjacent fixed teeth is larger than a maximum width of each moving tooth to keep one side of the moving tooth from touching the corresponding one of the fixed teeth; and
a distance between adjacent moving teeth is larger than a maximum width of each fixed tooth to keep one side of the fixed tooth from touching the corresponding one of the moving teeth.

2. The tree pruner as claimed in claim 1 further comprising an upper holder securely attached to the top end of the support rod for the fixed blade and the at least one lower pulley being mounted on the upper holder.

3. The tree pruner as claimed in claim 1 further comprising a saw adjustably mounted attached to the upper holder at an angle.

4. The tree pruner as claimed in claim 3, wherein the upper holder has two parallel flanges;
the saw is pivotally attached between the flanges with a pivot and has multiple notches defined in one end of the saw at a center of the pivot; and
an engaging bolt is operationally attached between the flanges to position the saw at desired angles.

5. The tree pruner as claimed in claim 3, wherein the engaging bolt has:
an engaging portion extending through one of the flange and into a space defined between the two flanges to correspond to the notches on the saw and to engage with one of the notches; and
a releasing portion co-axially extending from the engaging portion and extending through another flange, the releasing portion having a diameter smaller than that of the engaging portion;
a biasing member is mounted around the releasing portion at the end extending through the flange and having a first end abutting the flange through which the releasing portion extends and a second end; and
a pressing bolt is screwed to the releasing portion and abuts the second end of the biasing member.

6. The tree pruner as claimed in claim 3 further comprising a saw cover mounted on the support rod and having two parallel flanges with a space defined between the flanges to receive a free end of the saw when the saw is folded in a closed condition.

7. The tree pruner as claimed in claim 1 further comprising a cord holder secured on the bottom of the support rod to hold a bottom portion of the pull cord when the tree pruner is not in use.

8. The tree pruner as claimed in claim 7, wherein the cord holder has two parallel ears extending from the cord holder; and
each respective ear has a toothed face formed on a side of the ear facing the other ear to securely position the pull cord in cooperation with the toothed face on the other ear.

9. The tree pruner as claimed in claim 1, wherein each of the fixed teeth and the moving teeth has an oblique face formed on each respective side of a free end of the respective tooth.
